(19) United States
(12) Patent Application Publication
(10) Pub. No.: US 2026/0265084 A1
(43) Pub. Date: Sep. 10, 2026

(54) ONSITE THERMAL EVAPORATION AND TREATMENT SYSTEM FOR PRODUCED WASTEWATER IN OIL AND GAS OPERATIONS

(71) Applicant: Clayton Young, Columbia Falls, MT (US)

(72) Inventor: Clayton Young, Columbia Falls, MT (US)

(21) Appl. No.: 19/559,047

(22) Filed: Mar. 6, 2026

Related U.S. Application Data
(60) Provisional application No. 63/767,783, filed on Mar. 6, 2025.

(51) Int. Cl. C02F 1/04; C02F 1/00; C02F 1/38; C02F 9/20

(52) U.S. Cl. CPC C02F 1/048; C02F 1/004; C02F 1/38; C02F 9/20; C02F 2201/005

(57) ABSTRACT

The present invention relates to a mobile thermal evaporation system for onsite produced wastewater treatment, designed to efficiently separate liquid and solid components while ensuring environmental compliance. The system comprises a thermal evaporation unit that exposes wastewater to high temperatures, inducing phase transition from liquid to vapor. A combustion system, including a burner, provides the necessary heat, operating on natural gas, flare gas, or liquid fuels while maintaining low emissions. The vaporized stream undergoes multi-stage filtration, incorporating a cyclonic separator and a high-efficiency ceramic filter to remove residual particulates before atmospheric discharge. A solids management system, including a rotary airlock and a screw conveyor, collects and transports solid residues for disposal or reuse. The system eliminates the need for deep well injection, reducing transportation costs, regulatory burdens, and environmental risks while enabling cost-effective, onsite wastewater treatment for the oil and gas industry and other industrial applications.

### CROSS-REFERENCE TO RELATED APPLICATIONS

This application claims the benefit of U.S. Provisional Patent Application No. 63/767,783, filed Mar. 6, 2025, the entire contents of which are hereby incorporated by reference in their entirety.

### FIELD OF THE INVENTION

The present invention relates to the field of wastewater treatment and disposal, specifically to a system and method for the onsite treatment and disposal of produced water generated in oil and gas extraction processes. More particularly, the invention utilizes thermal evaporation and thermal treatment technologies to efficiently process wastewater at the production site, eliminating the need for transportation to offsite disposal wells and reducing environmental and regulatory challenges associated with traditional disposal methods. This invention is applicable to oil and gas drilling, hydraulic fracturing, flowback treatment, production well operations, and other industrial wastewater management processes.

### BACKGROUND

In the oil and gas industry, the extraction and production processes generate large volumes of wastewater, commonly referred to as produced water. This wastewater is a byproduct of activities such as drilling, hydraulic fracturing (fracking), flowback, and production wells, and contains a mixture of organic and inorganic compounds, high salinity, minerals, naturally occurring radioactive materials (NORM), and chemical additives. Proper disposal and treatment of produced water are critical due to its potential environmental hazards, regulatory constraints, and economic impact.

Currently, the predominant method for produced wastewater disposal is through Saltwater Disposal Wells (SDWs) or ground application techniques. While the methods provide a means of managing wastewater, they suffer from significant shortcomings in terms of environmental sustainability, cost, and safety risks. Produced water must be transported from the production site to an SDW, which introduces the risk of spills during transit. Spills can lead to hazardous waste contamination, requiring immediate containment, cleanup, and environmental damage assessments. Additionally, the transportation process involves high operational costs, including fuel expenses, truck hauling fees, and discharge fees. SDWs also pose major environmental threats, including the risk of groundwater contamination, as injected wastewater may migrate into freshwater aquifers, potentially impacting drinking water supplies. The process of deep well injection has been linked to induced seismic activity, leading to earthquakes in some regions. Surface spills and soil contamination at SDW sites further exacerbate environmental concerns, requiring costly remediation efforts. To address the concerns, various onsite treatment technologies have been explored, such as filtration systems, membrane separation technologies, distillation processes, selective ion precipitation, and reverse osmosis (RO). While the methods offer potential solutions, they suffer from high operational costs, complex maintenance requirements, and scalability issues. Many of the treatment systems require skilled personnel for continuous operation and upkeep, making them economically unfeasible for widespread adoption. Additionally, limited success has been observed in large-scale implementations, preventing the technologies from becoming a standard solution for wastewater disposal.

Given the economic and environmental challenges posed by existing disposal and treatment methods, there is an urgent need for an innovative, cost-effective, and environmentally sustainable solution for managing produced water in the oil and gas industry. An ideal solution should eliminate the need for transporting wastewater to distant disposal wells, reducing costs and spill risks. It should mitigate environmental hazards by preventing groundwater contamination, soil pollution, and seismic activity. Furthermore, it should provide an efficient onsite treatment system that is scalable, cost-effective, and easy to operate without requiring specialized personnel, while ensuring compliance with regulatory requirements. The present invention addresses these shortcomings by offering an onsite thermal evaporation and treatment system that enables direct disposal of produced wastewater at the production site. By integrating thermal treatment technologies, the system significantly reduces costs, regulatory paperwork, and environmental risks, making it a viable and effective alternative to traditional disposal and treatment methods.

### BRIEF SUMMARY

The present invention provides an on-site wastewater treatment and disposal system using thermal evaporation and thermal treatment to process produced wastewater directly at the production site. This eliminates the need for transportation to off-site disposal facilities, significantly reducing costs, regulatory paperwork, and record-keeping burdens. Additionally, the system helps mitigate environmental risks by minimizing or eliminating the potential for groundwater contamination.

The mobile evaporator system is an advanced onsite wastewater treatment system specifically designed for produced water disposal in the oil and gas industry. This mobile evaporator system effectively reduces high total dissolved and undissolved solid-laden wastewaters by employing a downward-fired thermal oxidizer evaporator in conjunction with a filtration and particulate removal system. Unlike traditional disposal methods that require transporting wastewater to Saltwater Disposal Wells (SDWs) or using high-maintenance filtration systems, the present invention enables direct onsite treatment by converting wastewater into vapor while safely collecting residual solid waste for disposal. The system is powered by site-supplied combustion gas and 480-volt electricity, ensuring that it operates efficiently within existing oil and gas production sites without the need for extensive infrastructure modifications. At its core, the system utilizes a direct contact evaporator that heats and vaporizes the produced water, separating the liquid component from dissolved and undissolved solids. The remaining sludge and solid residues are safely collected and disposed of, either at a landfill or directly onsite, depending on environmental and regulatory guidelines. The system is highly versatile and can function as a standalone unit or be integrated with other wastewater treatment technologies as part of a comprehensive produced water management system.

The evaporation process begins with the injection of produced water in an atomized form into a vortometric natural gas combustion burner. This burner, along with atomizing injection nozzles, ensures that the process water is efficiently mixed with high-temperature combustion gases in a downwardly directed central mixing zone. This controlled interaction results in the rapid vaporization of water while simultaneously oxidizing volatile organic compounds (VOCs) to ensure compliance with environmental regulations. The hot combustion gases travel through the evaporation zone, where water molecules transition into vapor, leaving behind concentrated salts, metals, and other solid contaminants. To prevent air pollution and ensure environmental compliance, the system includes multiple stages of particulate removal and filtration. As the dry solids are formed, they are directed through a cyclonic scrubber section and secondary cyclonic separator to facilitate efficient removal and collection. The solids are prevented from becoming re-entrained in the vapor stream through the use of a cooling air curtain injection nozzle arrangement. The collected solids are then discharged via a rotary airlock device and transported by a conveyor system to an external collection device. The system further enhances air quality compliance with a second-stage high-temperature ceramic filter unit, which ensures high-efficiency removal of fine particulates, including micron-sized solid contaminants. As a result, the clean water vapor generated by the system is exhausted directly into the atmosphere, meeting stringent ambient air quality standards. The particulate matter emissions from the system are kept to an exceptionally low range, between 0.005 and 0.08 grains per dry standard cubic foot (grains/DSCF), ensuring minimal environmental impact. Additionally, the oxidation process eliminates VOC emissions, making this an environmentally responsible solution for wastewater disposal. The disclosed mobile evaporator system provides a cost-effective, environmentally sustainable, and highly efficient solution for the treatment and disposal of produced wastewater in the oil and gas industry. By enabling onsite thermal evaporation, the system eliminates the need for transportation to disposal wells, reduces operational costs, and minimizes environmental risks such as groundwater contamination and seismic activity associated with deep-well injection. Its modular and mobile design allows for easy deployment across different production sites, making it a scalable solution for large-scale wastewater management.

Further, a summary of the claimed invention includes a system for onsite treatment of produced wastewater that integrates thermal evaporation, combustion-based heating, vapor purification, and automated solids handling to separate water from dissolved and suspended contaminants. The system includes a thermal evaporation unit configured to receive wastewater and convert the liquid component to vapor while leaving behind solid residues. The evaporation process is supported by a combustion system that generates heat using a fuel source, such as natural gas, flare gas, or liquid fuels, while maintaining low emission characteristics. In certain embodiments, the thermal evaporation unit includes a downward-fired evaporator that exposes atomized wastewater to high temperatures to promote rapid phase transition from liquid to vapor. The wastewater may be atomized prior to entering the evaporation unit and introduced into a combustion region to enhance heat transfer and accelerate evaporation and thermal treatment. The resulting vapor stream is directed through a vapor treatment section that includes a multi-stage particulate removal arrangement comprising a cyclonic separator and a ceramic filter, wherein the cyclonic separator increases gas velocity and separates solid particulates from the vapor stream and the ceramic filter removes remaining fine particulate matter. The system further includes a solids management system configured to collect and remove solid residues generated during evaporation. The solids management system may include a solids discharge valve, such as a double dump valve or rotary airlock valve, that isolates the evaporation unit while allowing solids removal, and a screw conveyor that transports the collected solids to an external collection container, such as a roll-off container. The combustion system may additionally receive combustion air from a combustion or dilution air source to support burner operation. After passing through the vapor treatment section, the treated vapor stream is released to the atmosphere substantially free of particulate contaminants.

In certain embodiments, the burner and the downward fired evaporator section collectively function as a thermal oxidation reactor for treatment of dissolved organic contaminants present in the produced water stream. Produced water associated with hydraulic fracturing operations frequently contains chemical additives used during drilling and stimulation processes, including surfactants, friction reducers, corrosion inhibitors, scale inhibitors, and biocides. When atomized wastewater droplets are introduced into the combustion zone, these compounds are exposed to elevated temperatures and oxidative conditions created by the combustion gases. The high temperature environment promotes thermal decomposition and oxidation of the organic compounds into simpler gaseous species. Accordingly, the disclosed system not only converts the liquid component of the wastewater into vapor through evaporation but also destroys dissolved organic contaminants through thermal oxidation, thereby improving the overall environmental performance of the treatment process.

In certain embodiments, the system further operates as a thermal oxidation unit in addition to functioning as a thermal evaporation system. Produced wastewater generated from oil and gas extraction processes, particularly hydraulic fracturing operations, commonly contains dissolved chemical additives including surfactants, friction reducers, corrosion inhibitors, scale inhibitors, biocides, and other treatment compounds that may present environmental or regulatory concerns if discharged untreated. In the disclosed system, wastewater introduced into the thermal evaporation unit is atomized and exposed to elevated temperatures within a combustion region generated by the burner. The high temperature combustion gases and turbulent mixing conditions present within the downward-fired evaporator section subject the dissolved organic compounds to thermal oxidation conditions sufficient to break down or destroy the chemical compounds. As a result, the system simultaneously performs two treatment functions, namely evaporation of the water component and thermal oxidation of dissolved chemical contaminants. This dual-function configuration enables the system to reduce both liquid wastewater volume and chemical contaminant load prior to discharge of the treated vapor stream.

The disclosed system provides several technical advantages resulting from the integrated combination of thermal evaporation, combustion heating, particulate separation, and automated solids handling. By converting produced wastewater into vapor and isolating salts, minerals, and other contaminants as solid residues, the system enables effective onsite wastewater treatment and significantly reduces reliance on transportation of wastewater to remote disposal wells. The downward-fired evaporator and atomized injection configuration improve heat transfer efficiency and promote rapid evaporation, thereby increasing treatment capacity and operational efficiency. The use of a multi-stage vapor treatment section incorporating cyclonic separation and ceramic filtration enables high-efficiency particulate removal and supports compliance with environmental emission standards before atmospheric discharge. Additionally, the solids management system incorporating discharge valves, rotary airlocks, and screw conveyors allows continuous removal and transport of solid residues without interrupting system operation. The ability to utilize various fuel sources and combustion air supply further enhances adaptability for deployment at different production sites. Collectively, the disclosed features enable a mobile, efficient, and environmentally compliant solution for managing high-salinity produced wastewater streams generated in oil and gas operations and other industrial applications.

### BRIEF DESCRIPTION OF THE ACCOMPANYING DRAWINGS

The novel features which are believed to be characteristic of the present invention, as to its structure, organization, use, and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention. Embodiments of the invention will now be described by way of example in association with the accompanying drawings in which:

FIG. 1 is a schematic representation showcasing an onsite thermal evaporation and treatment system for produced wastewater, in accordance with an embodiment of the present invention.

FIGS. 2a-2c is a block diagram that illustrates a two-stage thermal evaporation and filtration system designed for the onsite treatment of produced wastewater, in accordance with an embodiment of the present invention.

Further areas of applicability of the present invention will become apparent from the detailed description provided hereinafter. It should be understood that the detailed description of exemplary embodiments is intended for illustration purposes only and is, therefore, not intended to necessarily limit the scope of the invention.

### DETAILED DESCRIPTION

As used in the specification and claims, the singular forms “a”, “an”, and “the” may also include plural references. For example, the term “an article” may include a plurality of articles. Those with ordinary skill in the art will appreciate that the elements in the figures are illustrated for simplicity and clarity and are not necessarily drawn to scale. For example, the dimensions of some of the elements in the Figures may be exaggerated, relative to other elements, to improve the understanding of the present invention. There may be additional components described in the foregoing application that are not depicted on one of the described drawings. In the event such a component is described, but not depicted in a drawing, the absence of such a drawing should not be considered as an omission of such design from the specification.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

The words “comprising,” “having,” “containing,” and “including,” and other forms thereof, are intended to be equivalent in meaning and be open ended in that an item or items following any one of these words is not meant to be an exhaustive listing of such item or items or meant to be limited to only the listed item or items. Unless stated otherwise, terms such as “first” and “second” are used to arbitrarily distinguish between the elements. Thus, these terms are not necessarily intended to indicate temporal or other prioritization of such elements. While various exemplary embodiments of the disclosed invention have been described below it should be understood that they have been presented for purposes of example only, not limitations. It is not exhaustive and does not limit the invention to the precise form disclosed. Modifications and variations are possible considering the above teachings or may be acquired from practicing of the invention, without departing from the breadth or scope.

The present invention relates to a system and method for treating produced wastewater generated from oil and gas extraction and other industrial processes. The present invention has, as a primary objective, to provide an environmentally responsible and operationally practical solution for disposal and treatment of produced wastewater generated in oil and gas operations, while avoiding or substantially reducing reliance on saltwater disposal wells and other disposal techniques that inject contaminated water into the ground or discharge it on the surface. The objective is achieved by configuring the disclosed system as an onsite, mobile, high-temperature evaporation and thermal treatment apparatus that converts produced water into a vapor phase and physically separates and collects the dissolved and suspended solids as a dry or substantially dry residual stream. By performing treatment at the production location, the invention reduces or eliminates the transportation of contaminated water to remote disposal sites, thereby reducing spill risk and associated environmental exposure, while also reducing costs and administrative burdens associated with trucking, discharge fees, and disposal well availability constraints.

Another objective of the invention is to provide a produced water treatment system capable of handling produced water streams that include high levels of total dissolved solids (TDS) and total suspended solids (TSS), including salts, minerals, metals, and other particulates, while also addressing organic constituents such as volatile organic compounds (VOCs). The objective is achieved through an integrated thermal evaporation pathway in which produced water is introduced as atomized droplets into a high-temperature region so that the water content rapidly transitions from liquid to vapor while solids are concentrated and separated. The invention employs a downward-fired evaporator section that forces the evaporated produced water and associated gas stream into a high-velocity rotational flow regime that promotes centrifugal separation of formed salts and particulate matter into a lower region of the chamber, thereby increasing removal efficiency of solids even under high particulate loading conditions. In addition to converting the water component of the produced wastewater to vapor, the system is configured to thermally oxidize dissolved organic chemicals and compounds contained in the produced water stream. Produced water generated during hydraulic fracturing operations often contains various chemical additives including surfactants, friction reducers, corrosion inhibitors, scale inhibitors, biocides, and other treatment chemicals that may be hazardous or environmentally harmful if released untreated. When the atomized produced water is introduced into the combustion region of the burner and the downward fired evaporator section, these dissolved chemicals and compounds are exposed to elevated temperatures and oxidative conditions sufficient to thermally oxidize or decompose the compounds into simpler gaseous products. As a result, the system functions not only as a thermal evaporator but also as a thermal oxidation unit that destroys dissolved organic contaminants while converting the water component to vapor.

Another objective of the invention is to ensure reliable, high-intensity heating with stable combustion, high turndown capability, and reduced criteria pollutant emissions, such as NOx and CO, in an onsite unit that may be deployed under variable field conditions. The objective is achieved through the use of a vortometric burner configured as a fuel-fired burner producing an intense combustion air and fuel swirl rate that stabilizes the flame and supports efficient heat release over a broad operating range. The disclosure further supports the objective of field deployability by enabling the burner to operate on multiple combustible sources available at or near the production site, including natural gas and other combustible gases, and optionally flare gas, liquid waste fuels, oils, or other flammable mixtures, thereby reducing dependence on transported fuels and enabling practical integration into oilfield operations.

Another objective of the invention is to achieve robust destruction or substantial reduction of volatile organic compounds and other thermally oxidizable contaminants present in produced water, thereby allowing the exhaust stream to comply with environmental requirements and reducing release of VOCs to the atmosphere. The objective is achieved by the combined configuration of the atomizing injector, vortometric burner, and downward-fired evaporator section, wherein produced water is injected in atomized form into or proximate to the burner flame and/or hot combustion gas mixing zone such that VOCs are exposed to elevated temperature, residence time, and turbulence sufficient to promote thermal oxidation. The downward-fired evaporator section is disclosed as providing not only evaporation but also a high-temperature turbulent environment with retention time adequate to oxidize residual VOCs that may remain in the vapor stream after initial contact with the burner flame, thereby improving treatment completeness and emission compliance.

Another objective of the invention is to prevent operational fouling, plugging, or loss of performance that commonly occurs when treating produced water streams containing high solids, scaling species, and abrasive or corrosive constituents. The objective is achieved, in part, through the selection and configuration of atomizing injectors that utilize low-pressure air atomization and/or ultrasonic atomization nozzles, which are described as resistant to coking, blinding, and plugging by solids in the produced water stream. The objective is further supported by system architecture that separates solids through cyclonic mechanisms and discharges solids through controlled valves and conveyors, thereby limiting re-entrainment and accumulation in critical flow passages. Additionally, the disclosure recognizes the corrosive and abrasive nature of produced water and indicates that high-temperature, high-strength alloy materials may be used in burner and evaporator components exposed to the produced water stream and high operating temperatures, thereby improving durability, service life, and uptime.

Another objective of the invention is to enhance solids separation efficiency and ensure that particulate matter is removed from the vapor stream to meet stringent ambient air quality and particulate emission standards. The objective is achieved by arranging a cyclonic scrubber section downstream of the evaporation zone to further increase gas stream velocity prior to impingement and separation, thereby improving removal of solids and reducing particulate carryover. The disclosure further provides a cooling curtain having an annular injection plenum that introduces cooling air into the process stream to control moisture content and temperature of the exhaust gases such that moisture remains conveyed in the air stream without undesirable liquid separation, while also assisting in preventing re-entrainment of separated solids. A secondary particulate removal stage is also disclosed, including a high-temperature ceramic filter and/or a high-efficiency cyclone filter, to capture fine solids that may not have been removed in the initial stage, thereby enabling the exhaust to be discharged with particulate emissions in a low range (e.g., less than about 0.005 to 0.08 grains/DSCF as described) while maintaining low VOC discharge due to the thermal oxidation stages.

Another objective of the invention is to provide a controlled and automated mechanism for removing, drying, and collecting the solid residuals produced by evaporation of high-salinity produced water, in a manner that supports continuous operation and practical waste handling at field sites. The objective is achieved by providing solids collection systems that remove particulate buildup from the downward-fired evaporator section and from the secondary particulate removal stage. In the disclosed embodiments, solids discharge may be implemented using a double dump valve arrangement or a rotary airlock, optionally motor-driven, to isolate the process chamber while allowing continuous or semi-continuous solids discharge. A screw conveyor and/or conveyor transport mechanism then transfers the solids to a collection device outside the evaporator, including roll-off containers. The disclosure further contemplates a heated screw conveyor design to ensure solids are fully or substantially dried prior to being dropped into the containers, and describes provision of heat via a coil wrapped around the evaporator housing and located under insulation to circulate a heated fluid for the conveyor screw, thereby reducing clumping, bridging, or wet carryover and improving the handling characteristics of the recovered salts and mineral residues.

Another objective of the invention is to provide a mobile and modular system that can be deployed to different production sites, scaled to different produced water flow rates, and integrated into broader produced water management systems as needed. The objective is achieved by configuring the evaporator as a mobile unit powered by site-available resources (including combustion gas and electrical power) and by supporting operational capacities such as 20 gpm and 40 gpm designs, which correspond to practical oilfield throughput levels. The disclosure also supports modularity and uptime through redundant injector nozzle arrangements; for example, multiple injector nozzles may be installed such that only a subset is required for operation while additional nozzles provide safety redundancy and allow removal, cleaning, and reinstallation without shutting down the system, thereby improving operational continuity and reducing downtime in remote field environments.

Another objective of the invention is to optionally enable beneficial reuse of treated water and/or recovery of energy, thereby increasing overall system value beyond mere disposal. The objective is achieved through alternative embodiments disclosed in which the clean water vapor exhaust stream can be processed through an additional contact cooler or condenser stage to condense water from the exhaust stream for recycling and reuse in oil and gas processes, and in which a waste heat boiler may be coupled to the system to generate steam onsite. These optional features allow the system to be configured either as a disposal-focused evaporator or as a resource recovery platform depending on site needs, regulatory requirements, and economic drivers, while still leveraging the core thermal evaporation and solids separation architecture of the invention.

Accordingly, the disclosed invention achieves its objectives through the coordinated combination of (i) atomized produced water injection into a high-intensity vortometric burner region for rapid evaporation and VOC oxidation, (ii) a downward-fired evaporator section that provides high-temperature residence time and rotational separation of solids, (iii) cyclonic scrubbing and controlled cooling via an air curtain to prevent re-entrainment and maintain stable moisture transport, (iv) optional or mandatory secondary particulate removal via ceramic filtration and/or cyclone filtration to meet air emissions requirements, and (v) automated, heat-assisted solids discharge and conveyance to roll-off containers or other collection devices for practical onsite solids handling. The resulting system provides a mobile, scalable, and environmentally compliant produced water treatment solution that reduces transportation risks, mitigates groundwater contamination hazards associated with injection disposal, and lowers overall operational and regulatory burdens for operators managing high-salinity produced wastewater streams.

The present invention will now be described with reference to the accompanying drawings which should be regarded as merely illustrative without restricting the scope and ambit of the present invention.

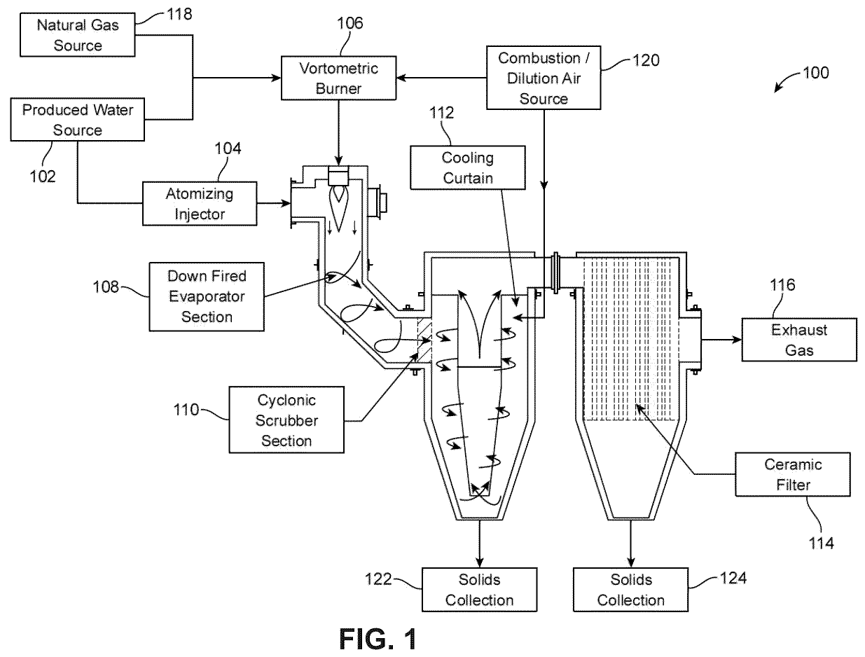

FIG. 1 is a schematic representation showcasing an onsite thermal evaporation and treatment system 100 for produced wastewater, in accordance with an embodiment of the present invention.

The produced water source 102 refers to the contaminated water generated as a byproduct of oil and gas extraction activities, including brine, fracking fluid, drilling fluids, and other wastewater from production wells. This water contains a mixture of dissolved and undissolved solids, heavy metals, hydrocarbons, and naturally occurring radioactive materials (NORM), making its disposal a significant environmental challenge. In addition to the oil and gas industry, similar wastewater treatment needs exist in other industrial sectors such as mining, chemical manufacturing, and power generation.

The atomizing injector 104 is an essential component that ensures the efficient evaporation of produced water by converting it into fine droplets before introducing it into the combustion process. The atomization process allows for greater surface area exposure to heat, ensuring rapid phase transition from liquid to vapor. The injector 104 utilizes low-pressure air or ultrasonic nozzles designed to prevent clogging, a common issue when processing high-solid-content wastewater. By avoiding coke formation, blinding, or plugging, the system maintains operational efficiency over prolonged use.

The vortometric burner 106 is a specialized multi-fuel burner that generates the intense heat required for the evaporation process. The burner 106 operates with high combustion air, liquid, and gas swirl rates, producing a stable flame with high turndown capability. It can maintain efficiency across a range of operational loads. Unlike conventional burners, the burner 106 is designed to achieve low nitrogen oxide (NOx) and carbon monoxide (CO) emissions, reducing its environmental impact. It can operate using various fuels, including natural gas, flare gas, liquid waste, and oils, making it adaptable to different site conditions where the fuel sources are readily available.

The downward fired evaporator section 108 represents the first stage of the wastewater treatment process. Here, the produced water droplets undergo rapid thermal evaporation, where high-velocity rotational forces help separate solid contaminants from the water-saturated air stream. This section 108 ensures a high removal efficiency of salts, minerals, and other particulates. Additionally, turbulence and retention time at elevated temperatures allow for thermal oxidation of any residual volatile organic compounds (VOCs) in the wastewater, ensuring compliance with air quality regulations. For example, in fracking operations, the evaporator section 108 helps break down hydrocarbons and organic contaminants before they are released into the environment.

The cyclonic scrubber section 110 further enhances the separation process by increasing air velocity and directing the vapor stream toward an alloy cone, where heavier solid particles are removed due to centrifugal forces. This ensures that solid residues are efficiently separated before moving to the next stage. Cyclonic scrubbers are widely used in industrial gas treatment systems to capture fine particulates. In the present invention, they play a crucial role in ensuring that salt deposits, heavy metals, and residual contaminants are properly removed before the vapor exits the system.

The cooling curtain 112 is an essential air injection mechanism that prevents moisture condensation and particulate re-entrainment in the exhaust stream. The cooling curtain 112 consists of an annular injection plenum that introduces cooling air into the process stream, ensuring that the moisture-laden air maintains proper flow characteristics. Without adequate cooling, vapor condensation could lead to blockages or inefficient exhaust emissions, affecting system performance. A practical example of cooling air injection is seen in industrial flue gas treatments, where controlled cooling prevents acid condensation and corrosion in exhaust ducting systems.

The ceramic filter 114 serves as a secondary stage filtration system that ensures high-efficiency removal of fine particulates. The filter 114 captures any remaining micron-sized solids that might have escaped the initial separation processes. Ceramic filters are known for their high-temperature resistance and durability, making them ideal for treating highly contaminated gas streams. Their application in the present invention ensures compliance with environmental regulations for particulate emissions, similar to how ceramic filters are used in diesel engine exhaust systems to trap soot and fine particulates. Further, the system may include a cyclone filter that operates in conjunction with the ceramic filter 114 to remove additional fine particulate matter that may still be present in the gas stream. The cyclone filter uses centrifugal force to separate remaining particles, ensuring that the final exhaust air is clean and meets stringent air quality standards.

The exhaust gases 116 represent the final stage of the treatment process, where the clean, particulate-free water vapor is released into the atmosphere. By the time the vapor exits the system, it has undergone multiple stages of filtration and thermal oxidation, ensuring that volatile organic compounds (VOCs) and harmful particulates are removed or reduced to permissible levels. The system's emission levels are kept within 0.005 to 0.08 grains per dry standard cubic foot (grains/DSCF), meeting regulatory requirements for air pollution control.

The natural gas source 118 provides the primary fuel input for the burner 106, allowing for efficient heat generation. In oil and gas production sites, natural gas is often available as a byproduct, reducing the need for external fuel sources. In cases where flare gas is available, it can be used as an alternative fuel, promoting waste gas utilization and reducing overall emissions.

The combustion/dilution air source 120 is a blower system that delivers the necessary air for combustion, ensuring that the burner achieves optimal operating temperature. The correct air-to-fuel ratio is crucial for efficient combustion, minimizing excess emissions while maximizing heat output. This blower system also contributes to flame stability and operational efficiency in varying environmental conditions.

The solids collection system 122 and 124 is responsible for automatically removing accumulated solid particulates from the system. The first-stage solids collection 122 captures heavy solids from the downward fired evaporator section, while the second-stage solids collection 124 removes any remaining particulates from the ceramic filter section. Both systems 122 and 124 use a double dump damper mechanism, a screw conveyor rotary airlock, and an external collection system, ensuring that solids are efficiently transported to a designated disposal or storage site. In real-world applications, the system prevents clogging and buildup, reducing maintenance requirements and ensuring continuous operation.

Referring to FIG. 1, the operation of the produced wastewater treatment system begins with the produced water source 102, which provides contaminated wastewater generated from oil and gas extraction operations. The produced water may include brine, flowback fluids, drilling fluids, fracking fluids, and other wastewater streams containing dissolved salts, suspended solids, metals, organic compounds, and other contaminants. The produced water is supplied to the treatment system for onsite processing, thereby eliminating or substantially reducing the need to transport wastewater to remote saltwater disposal wells and minimizing environmental risks associated with transportation and deep well injection.

In operation, a portion of the produced water is directed to the atomizing injector 104. The atomizing injector 104 is configured to convert the produced water into a finely atomized spray prior to introduction into the thermal evaporation unit. In certain embodiments, the atomizing injector 104 utilizes low-pressure air atomization or ultrasonic atomization nozzles to produce fine droplets having increased surface area relative to bulk liquid. The atomization process facilitates efficient heat transfer and rapid phase change during subsequent thermal treatment. The injector configuration is further selected to prevent clogging, coking, or plugging that may otherwise occur due to the presence of high concentrations of dissolved solids or suspended particulates within the produced water stream.

The atomized wastewater generated by the atomizing injector 104 is introduced into a combustion region associated with the burner 106. The burner 106 forms part of the combustion system and generates the heat necessary for evaporation of the wastewater. The burner 106 receives fuel from the natural gas source 118 or from other available combustible gas streams present at the drilling site, including flare gas, liquid fuels, waste fuels, or oil-based fuels. A combustion or dilution air source 120 supplies combustion air required for burner operation and supports complete combustion within the combustion chamber. The burner 106 is preferably configured as a high-swirl burner capable of producing a stable flame and uniform heat distribution while maintaining low emissions of nitrogen oxides and carbon monoxide.

Heat generated by the burner 106 is directed into the downward fired evaporator section 108, which forms the primary thermal evaporation unit of the system. The downward fired evaporator section 108 receives the atomized wastewater droplets within a high-temperature gas stream produced by the burner. The thermal energy supplied by the burner rapidly converts the atomized liquid droplets into vapor, thereby separating the liquid component of the wastewater from the dissolved and suspended solid contaminants. The downward orientation of the evaporator section 108 promotes effective residence time and turbulent mixing, ensuring efficient heat transfer and rapid vaporization of the water content.

Within the downward fired evaporator section 108, the high-velocity heated gas stream induces rotational flow patterns that generate centrifugal forces within the chamber. These forces facilitate separation of solid particulates, including salts, minerals, metals, and other residual contaminants, from the vapor stream. The elevated temperature, turbulence, and residence time present within the downward fired evaporator section further create conditions sufficient to thermally oxidize volatile organic compounds and dissolved chemical additives present in the produced water stream.

In certain embodiments, the burner 106 and the downward fired evaporator section 108 collectively function as a thermal oxidation reactor in addition to serving as a thermal evaporation system. Produced water generated from hydraulic fracturing operations frequently contains dissolved chemical additives introduced during drilling and stimulation processes, including surfactants, friction reducers, corrosion inhibitors, scale inhibitors, biocides, and other treatment compounds. When the produced water is atomized by the injector 104 and introduced into the high-temperature combustion region generated by the burner 106, the dissolved organic compounds are exposed to elevated temperatures and oxidative conditions sufficient to promote thermal decomposition and oxidation of the chemical compounds. As a result, the system simultaneously performs evaporation of the liquid water component and thermal oxidation of dissolved chemical contaminants present in the wastewater stream.

The vaporized water stream exiting the downward fired evaporator section 108 may still contain entrained particulate matter. The vapor stream therefore proceeds to the cyclonic scrubber section 110, which forms part of the vapor treatment section. The cyclonic scrubber section 110 increases the velocity of the gas stream and directs the flow into a cyclonic separation zone that enhances removal of remaining particulate matter. The rotational flow within the cyclonic scrubber section forces heavier particles toward the outer wall of the chamber where they are separated from the vapor stream and directed downward for removal.

Downstream of the cyclonic scrubber section 110, the system incorporates a cooling curtain 112. The cooling curtain 112 includes an annular injection plenum configured to introduce cooling air into the exhaust stream. The injected cooling air reduces the temperature of the exhaust gases and stabilizes the moisture content of the vapor stream. This controlled cooling prevents condensation of water vapor within the gas stream and minimizes the risk of particulate re-entrainment that might otherwise occur if moisture were to condense within the system.

Following the cooling curtain stage, the vapor stream is directed to a secondary particulate removal stage comprising the ceramic filter 114 and/or a cyclone filter. The ceramic filter 114 is a high-temperature filtration element configured to capture fine particulate matter that may remain within the vapor stream after the initial cyclonic separation stage. In certain embodiments, the secondary particulate removal stage may include a high-velocity cyclone filter positioned downstream of the ceramic filter to further improve particulate removal efficiency. The combined operation of the cyclonic scrubber section and the ceramic filtration stage ensures that the vapor treatment section effectively removes particulate matter prior to discharge of the vapor stream.

The thermal oxidation occurring within the combustion region and the downward fired evaporator section reduces the concentration of organic compounds and chemical additives contained in the produced water stream prior to discharge of the treated vapor. This oxidation process assists in converting complex organic chemicals into simpler gaseous products and thereby reduces the release of hazardous chemical compounds that may otherwise remain in the wastewater. Consequently, the system operates not only as a thermal evaporator for separating water from dissolved solids but also as a thermal treatment unit capable of destroying dissolved organic contaminants associated with produced water streams.

After passing through the vapor treatment section, the treated vapor stream is substantially free of particulate contaminants and volatile organic compounds. The resulting clean exhaust gases 116 are discharged through an exhaust outlet to the atmosphere. The system is configured such that the treated vapor stream complies with applicable air quality regulations, including particulate emission limits that may be reduced to levels in the range of approximately 0.005 to 0.08 grains per dry standard cubic foot.

During operation, solid residues generated within the evaporation and particulate separation stages accumulate within the lower portion of the system. These solid residues are automatically removed through the solids management system comprising solids collection systems 122 and 124. The solids management system includes a solids discharge valve that may comprise a double dump damper or a rotary airlock mechanism. The solids discharge valve maintains pressure isolation within the evaporator chamber while allowing controlled removal of accumulated solids. Once discharged through the solids discharge valve, the collected solids are transported by a screw conveyor associated with the solids collection system. The screw conveyor transfers the solids from the downward fired evaporator section and from the secondary particulate removal stage to an external collection container positioned adjacent to the treatment unit. In certain embodiments, the external collection container may comprise a roll-off container configured to receive the dried solid residues for transport and disposal. The use of the screw conveyor and rotary airlock arrangement allows continuous removal of solids during system operation without interrupting the evaporation process. Through the coordinated operation of the atomizing injector 104, burner 106, downward fired evaporator section 108, cyclonic scrubber section 110, cooling curtain 112, ceramic filter 114, exhaust outlet 116, and solids management systems 122 and 124, the disclosed system efficiently converts contaminated produced water into clean vapor while isolating solid contaminants for disposal. The system thereby provides a practical onsite wastewater treatment solution that reduces environmental risks, lowers transportation costs, and improves operational efficiency for oil and gas production facilities.

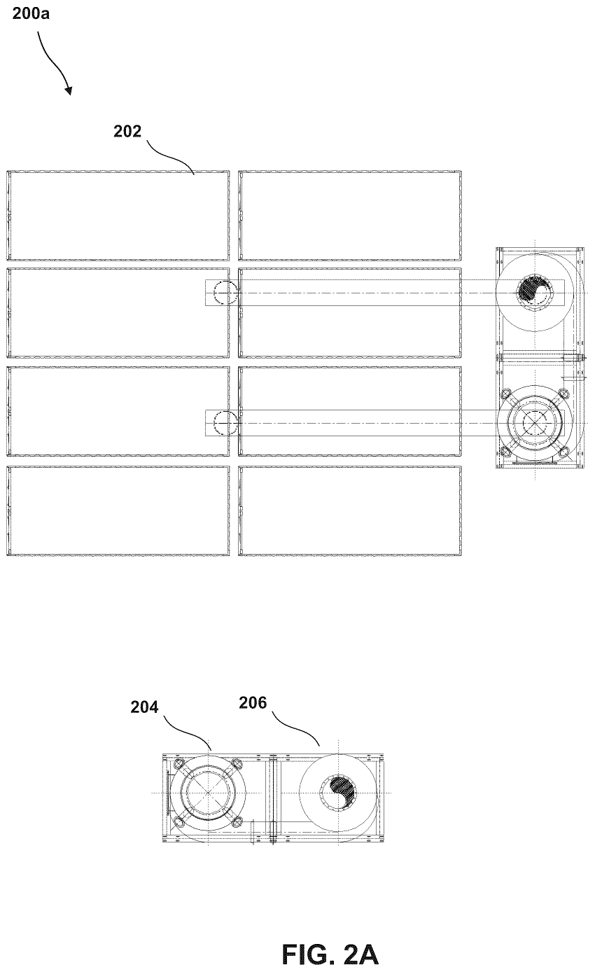

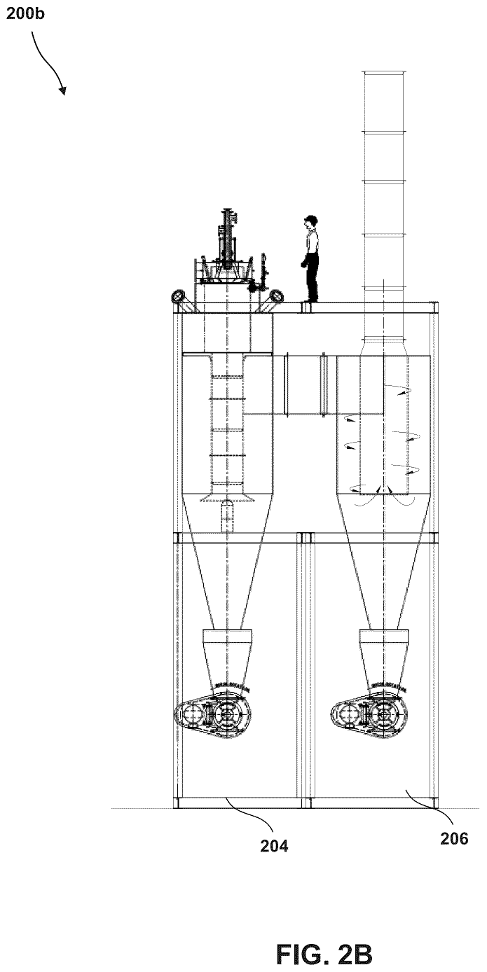

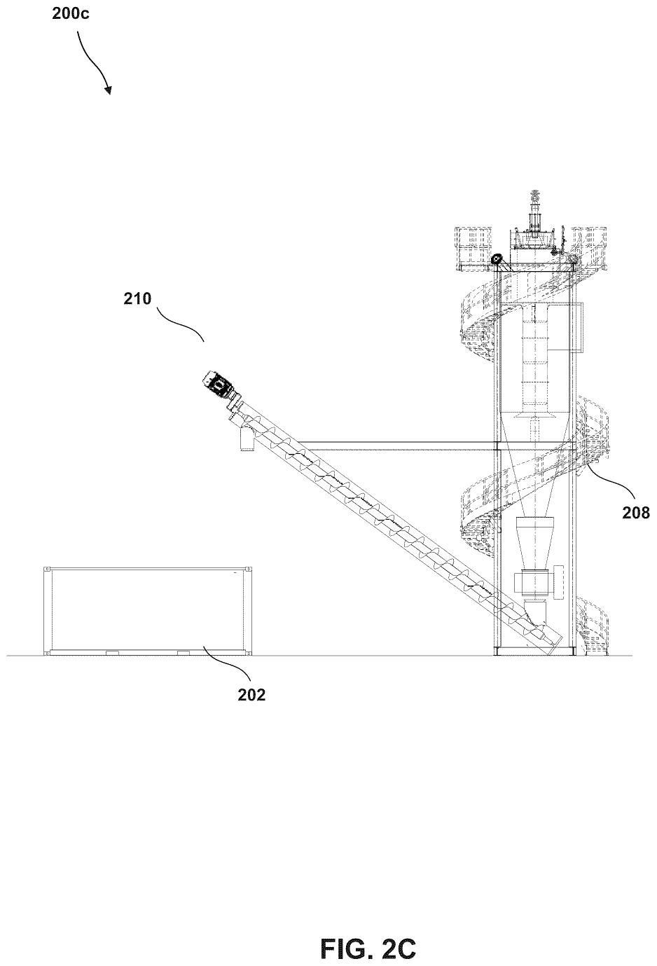

FIGS. 2a-2c is a block diagram that illustrates a two-stage thermal evaporation and filtration system designed for the onsite treatment of produced wastewater, in accordance with an embodiment of the present invention. The system utilizes high-temperature evaporation, advanced filtration, and solid waste collection mechanisms to efficiently process wastewater while ensuring compliance with environmental regulations. The schematic comprises multiple views, including a top view 200a, front view 200b, and side view 200c, depicting the functional components, fluid flow paths, and structural elements necessary for the effective operation of the system. At the bottom-left section of the schematic in FIG. 2c, a set of modular roll-off containers 202 is depicted, labeled as the produced water feed system. These containers 202 may serve as a storage unit for wastewater before it is introduced into the evaporation chamber. The use of mobile roll-off containers enhances system flexibility, allowing for easy transport and handling of wastewater at various production sites. These containers 202 enable continuous wastewater processing by providing a controlled and metered supply of produced water to the main treatment unit.

The primary processing unit, in both the side and front views, consists of a stage 1 evaporation section 204 and a stage 2 secondary filtration and particulate removal section 206. The stage 1 evaporation section 204 is a downward-fired thermal oxidizer evaporator, where the produced water is atomized and introduced into a high-temperature combustion environment. This section is responsible for rapid phase transition, converting wastewater into vapor while leaving behind solid contaminants such as salts, heavy metals, and minerals. The high-velocity rotational forces within the evaporator chamber aid in separating the solid impurities from the gas stream. The schematic depicts two distinct combustion chambers, each fitted with the burner 106 that ensures stable combustion with low NOx and CO emissions. The burners 106 use natural gas, flare gas, or alternative combustible fuels to generate the necessary heat for evaporation. The downward-directed flame path and turbulence mechanisms promote high thermal retention and efficient destruction of volatile organic compounds (VOCs). As the vaporized wastewater moves upward, it enters the stage 2 secondary filtration and particulate removal section 206, designed to eliminate residual particulates before the exhaust is released into the atmosphere. This section comprises a high-efficiency ceramic filter unit and a high-velocity cyclone filter. The ceramic filter removes fine particulate matter, including micron-sized contaminants, ensuring that the discharged air meets environmental air quality standards. The cyclone filter utilizes centrifugal force to capture any remaining solids, further reducing emissions. The schematic indicates that the exhaust gas emissions from the system are maintained at less than 0.08 grains per dry standard cubic foot (grains/DSCF), adhering to stringent regulatory requirements.

The bottom-right portion highlights the solids collection and handling mechanism. As solid waste accumulates within the evaporation chamber, it is automatically extracted using a screw conveyor and rotary airlock system. The heated screw conveyor 210, shown in the side view 200c, ensures that solid residues are efficiently transported without clogging. The heat is supplied via a water jacket surrounding the evaporator, preventing moisture condensation and maintaining smooth material flow. The collected solids, mainly salt and mineral deposits, are directed to an external collection system, where they can be either disposed of or repurposed for industrial applications. The schematic also features a spiral staircase 208, providing operator access to the upper sections of the unit for maintenance and inspection. This structural element enhances the system's operability and safety, allowing personnel to monitor combustion performance, burner operation, and filter efficiency. Additionally, exhaust stacks positioned at the top of the unit ensure the safe release of treated gases, maintaining proper airflow dynamics and preventing backpressure within the system. The provided schematic details a comprehensive thermal evaporation and particulate removal system designed for mobile deployment at the oil and gas production sites. The system integrates high-temperature evaporation, advanced filtration, and automated solid waste removal to provide an efficient, cost-effective, and environmentally compliant wastewater treatment solution. By leveraging onsite wastewater processing, the invention significantly reduces transportation costs, eliminates groundwater contamination risks, and minimizes air pollution, making it a viable and sustainable alternative to conventional produced water disposal methods.

In summary, the present invention relates to a system and method for treating produced wastewater generated from oil and gas extraction and other industrial processes. More particularly, the invention relates to a mobile thermal evaporation and treatment system configured to treat produced water at the production site using a downward fired evaporator combined with a vortometric burner, particulate separation system, and solids collection mechanism. The disclosed system enables the conversion of contaminated produced water into a vapor phase while separating and collecting dissolved and suspended solids, thereby eliminating or substantially reducing the need for transporting wastewater to remote disposal facilities. The produced water generated from drilling operations, hydraulic fracturing, flowback operations, and production wells typically contains high levels of salts, dissolved minerals, suspended solids, organic compounds, naturally occurring radioactive materials, and various chemical additives. The treatment and disposal of such produced water present significant environmental and operational challenges. The present invention addresses the challenges by providing a mobile evaporator system capable of converting the produced water into vapor through high temperature thermal evaporation while isolating solid contaminants for controlled disposal.

The invention includes a produced water source which may comprise brine, fracking fluids, drilling fluids, or other contaminated liquids produced during hydrocarbon extraction processes. The produced water source may also include wastewater streams generated in other industrial processes. The produced water is delivered to the treatment system where it is subjected to atomization and thermal processing.

In one embodiment of the invention, the produced water is introduced into the system through an atomizing injector. The atomizing injector is configured to convert the liquid produced water stream into a finely atomized spray before introduction into the combustion region of the system. The injector may utilize low pressure air atomization or ultrasonic atomization nozzles to generate a fine droplet distribution. The use of low pressure air or ultrasonic atomization prevents clogging, coking, or plugging that might otherwise occur due to the presence of high concentrations of dissolved or suspended solids in the produced water stream. In certain embodiments, multiple injector nozzles are provided to ensure operational redundancy. For example, four injector nozzles may be installed even though only two are required for operation. This configuration allows individual injectors to be removed, cleaned, or replaced without requiring shutdown of the system.

The atomized produced water is directed into a vortometric burner region. The vortometric burner is a fuel-fired burner configured to generate a high intensity combustion environment with a strong swirl of combustion air, liquid, and gas. The burner produces a stable high temperature flame capable of operating over a wide range of heat input conditions while maintaining low emissions of nitrogen oxides (NOx) and carbon monoxide (CO). The burner may operate using a variety of fuels including natural gas, flare gas, liquid waste fuels, oil-based fuels, or other combustible mixtures available at the production site. The burner generates the thermal energy required to initiate evaporation of the produced water and to oxidize volatile organic compounds contained within the water stream.

Downstream of the vortometric burner is a downward fired evaporator section which constitutes the primary evaporation chamber of the system. In the section, the atomized produced water droplets are exposed to the high temperature combustion gases generated by the burner. The downward orientation of the evaporator promotes controlled residence time and turbulent mixing conditions which facilitate rapid vaporization of the liquid water component. As the water is converted to vapor, dissolved salts, minerals, and other solid contaminants remain as particulate matter. The downward fired evaporator section further induces a high velocity rotational flow pattern within the evaporation chamber. The rotational flow generates centrifugal forces which separate the solid particles from the water-saturated gas stream. The heavier particulate materials migrate toward the outer regions of the chamber and settle toward the lower portion of the evaporation unit. This mechanism provides a high removal efficiency for solid contaminants such as salts, metals, and mineral deposits that form as the water evaporates.

The downward fired evaporator section also provides sufficient thermal retention time and turbulence to ensure thermal oxidation of residual volatile organic compounds that may remain in the vapor stream after initial contact with the burner flame. The combination of intense heat, turbulence, and residence time ensures destruction of VOCs contained within the produced water stream and contributes to compliance with environmental air quality regulations. Following the evaporation stage, the partially cleaned gas stream enters a cyclonic scrubber section. The cyclonic scrubber increases the velocity of the gas stream and directs it toward an alloy cone or similar impact structure which enhances separation of residual solids from the gas stream. The cyclonic action forces heavier particles outward toward the chamber walls where they are separated from the flowing vapor stream. This stage further increases the efficiency of solid particulate removal prior to discharge of the vapor.

In order to prevent re-entrainment of separated solids and to maintain proper moisture transport in the exhaust stream, the system further includes a cooling curtain section. The cooling curtain consists of an annular injection plenum configured to introduce cooling air into the gas stream exiting the evaporation and cyclonic stages. The injected cooling air reduces the temperature of the exhaust gases and controls the moisture content of the vapor stream. This ensures that moisture remains suspended in the air stream and prevents condensation or liquid separation which could otherwise lead to re-entrainment of solids.

After passing through the cooling curtain, the vapor stream proceeds to a secondary particulate removal stage. In one embodiment, the stage includes a high temperature ceramic filter designed to capture fine particulate matter that may not have been removed in the initial evaporation and cyclonic separation stages. The ceramic filter provides high efficiency removal of micron-sized solids and enables the system to meet strict environmental compliance standards for particulate emissions.

In an alternative embodiment, the ceramic filter may be replaced with or supplemented by a secondary cyclone filter which operates at high velocity to remove remaining particulate matter. The cyclone filter utilizes centrifugal separation principles to capture fine particles that remain suspended in the gas stream. Depending on regulatory requirements and the characteristics of the produced water being treated, either or both filtration technologies may be utilized.

After passing through the secondary filtration stage, the resulting vapor stream consists primarily of clean water vapor with minimal particulate content. The treated vapor is discharged through an exhaust stack to the atmosphere. The system is designed such that particulate emissions are maintained at extremely low levels, typically in the range of approximately 0.005 to 0.08 grains per dry standard cubic foot, thereby meeting stringent ambient air quality standards.

Solid residues generated during the evaporation process are collected and removed from the system through dedicated solids collection mechanisms. Solid particulates that accumulate in the lower portion of the downward fired evaporator section are discharged through a material handling valve system which may include a double dump damper configuration or a rotary airlock valve. These valves maintain pressure isolation within the evaporator while allowing solids to be periodically discharged. Once discharged, the solids are transported by a screw conveyor system to an external collection container such as a roll-off container positioned adjacent to the evaporator unit. In one embodiment, the screw conveyor is designed as a heated screw conveyor to ensure that the collected solids remain dry and free flowing. The heating may be supplied by a coil wrapped around the evaporator housing and buried within insulation surrounding the unit. A hot circulating fluid is circulated through the coil to provide heat to the conveyor assembly. The configuration ensures that the particulate material is completely dry before being discharged into the roll-off containers and prevents agglomeration or buildup of wet solids within the conveyor system.

The system may be configured to process the produced water at various flow rates depending on the design capacity of the unit. For example, a mobile evaporator unit may process approximately 20 gallons per minute or approximately 40 gallons per minute of produced water. At these flow rates, significant quantities of dissolved solids may be recovered from the water stream. For example, produced water with high concentrations of dissolved salts may produce several thousand pounds of solid residues per day which are collected in the roll-off containers for disposal or further processing.

In one configuration, the screw conveyor and associated hoses may be designed to swing laterally by approximately fifteen percent in either direction to allow filling of multiple roll-off containers without repositioning the evaporator unit. This feature enables efficient solids handling and reduces operational interruptions associated with container replacement. The entire evaporator system is configured as a mobile unit that may be transported to different oil and gas production sites. The system may be powered using site supplied combustion gas and electrical power, such as a 480 volt electrical supply commonly available in industrial settings. This mobility allows the system to be deployed directly at production wells or centralized collection points for produced water.

In certain embodiments, additional components may be incorporated into the system to enhance functionality. For example, an additional cooling stage may be installed downstream of the exhaust stream to condense the water vapor produced by the evaporation process. The condensed water may then be recovered and reused within the oil and gas production process. In another embodiment, a waste heat boiler may be integrated with the system to recover heat from the exhaust gases and generate steam for onsite industrial use.

Due to the corrosive and abrasive characteristics of the produced water, certain components of the system may be fabricated from high temperature and corrosion resistant alloys. In particular, portions of the vortometric burner and downward fired evaporator section may be constructed from specialized alloy materials capable of withstanding both high operating temperatures and corrosive exposure from salts and minerals contained in produced water streams. Through the combination of atomized injection, high temperature combustion, downward fired evaporation, cyclonic separation, cooling air injection, secondary filtration, and automated solids removal, the present invention provides an efficient and environmentally responsible solution for treating produced wastewater directly at the production site. The system significantly reduces reliance on saltwater disposal wells, eliminates many transportation-related risks, and provides a practical means of managing large volumes of produced water generated by oil and gas operations.

The disclosed mobile thermal evaporation system for onsite produced wastewater treatment offers several significant advantages over conventional wastewater disposal methods, particularly deep well injection and offsite transportation. One of the primary benefits of the system is its ability to eliminate the need for transporting wastewater to disposal wells, which significantly reduces transportation costs, fuel expenses, and regulatory challenges associated with wastewater hauling. By processing wastewater directly at the production site, the system mitigates environmental risks related to spills, leaks, and groundwater contamination, which are common issues with traditional wastewater disposal methods. Another major advantage of the system is its high thermal efficiency, achieved through the downward-fired evaporator and burner, which ensure rapid phase transition and efficient combustion. The multi-fuel capability of the burner allows the system to operate using natural gas, flare gas, liquid fuels, or alternative waste fuels, providing flexibility for different industrial environments while maintaining low NOx and CO emissions. The system's multi-stage filtration process, including a cyclonic separator and a ceramic filter, ensures high-efficiency removal of fine particulates, allowing the treated vapor to be safely released into the atmosphere while complying with stringent air quality regulations. The solids management system incorporated in the invention provides an automated and efficient method for handling solid waste, ensuring that salts, minerals, and heavy metal residues are safely collected and disposed of without requiring manual intervention. The inclusion of a rotary airlock and a heated screw conveyor prevents moisture condensation and ensures continuous operation with minimal maintenance requirements. This feature is particularly advantageous in industries where waste stream variability and high solid content pose challenges to conventional treatment methods. Additionally, the system is highly modular and mobile, meaning it can be transported and deployed at various production sites, making it an ideal solution for temporary or remote oil and gas operations, mining sites, or industrial processing plants. The onsite treatment capability reduces the reliance on large-scale wastewater treatment facilities, enabling companies to maintain operational independence and regulatory compliance in a cost-effective manner.

The mobile thermal evaporation system has a broad range of industrial applications, particularly in sectors that generate high-salinity wastewater with dissolved and undissolved solids. One of the primary applications is in the oil and gas industry, where produced water from hydraulic fracturing (fracking), drilling operations, and well production requires proper disposal. Traditional methods, such as deep well injection and surface discharge, pose significant environmental and regulatory challenges. By implementing the system, oil and gas operators can efficiently treat wastewater onsite, significantly reducing costs and mitigating environmental liabilities. Another key application is in the mining industry, where acid mine drainage (AMD) and process water contain high concentrations of heavy metals, sulfates, and other contaminants. The disclosed system can be utilized to evaporate and treat contaminated mining wastewater, ensuring that the residual solid waste is collected and disposed of in an environmentally responsible manner. This technology can also be adapted for chemical manufacturing and industrial process wastewater treatment, where complex waste streams require efficient separation and disposal solutions. Additionally, the system is beneficial in power generation facilities, particularly those that utilize water-intensive cooling systems and steam generation processes. The evaporation and filtration mechanisms allow for the onsite treatment of blowdown water, reducing the need for external water disposal and improving overall plant efficiency. The system can also be applied in large-scale desalination plants, where brine discharge presents environmental concerns. By integrating the evaporation technology, operators can manage concentrated brine disposal more effectively. Furthermore, the system is suitable for emergency response and disaster relief operations, where large-scale water treatment may be required in remote locations. The mobility and modular design of the system make it ideal for temporary deployment in regions affected by industrial spills, flooding, or other environmental emergencies.

The foregoing descriptions of specific embodiments of the present technology have been presented for purposes of illustration and description. They are not intended to be exhaustive or to limit the present technology to the precise forms disclosed, and obviously many modifications and variations are possible considering the above teaching. The embodiments were chosen and described to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology. While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed is:

1. A system for onsite produced wastewater treatment, comprising:
a thermal evaporation unit configured to receive and process wastewater to separate liquid and solid components;
a combustion system operable using a fuel source, the combustion system generating heat for evaporation;
a vapor treatment section configured to remove particulates from the vaporized wastewater before atmospheric release; and
a solids management system configured to collect and remove solid residues resulting from the evaporation process.

2. The system of claim 1, wherein the thermal evaporation unit comprises a downward-fired evaporator designed to expose wastewater to high temperatures for phase transition from liquid to vapor.

3. The system of claim 1, wherein the combustion system includes a burner configured to operate with natural gas, flare gas, or liquid fuels while maintaining low emissions.

4. The system of claim 1, wherein the vapor treatment section comprises a multi-stage filtration system, including a cyclonic separator and a ceramic filter, for high-efficiency particulate removal.

5. The system of claim 4, wherein the cyclonic separator is positioned downstream of the thermal evaporation unit to increase gas stream velocity and facilitate separation of solid particulates from the vapor stream.

6. The system of claim 4, wherein the ceramic filter is configured to remove fine particulate matter remaining in the vapor stream after cyclonic separation.

7. The system of claim 1, wherein the solids management system includes a rotary airlock and a screw conveyor for automatic transport and disposal of collected solid residues.

8. The system of claim 7, wherein the solids management system further comprises a solids discharge valve configured to isolate the evaporation unit while allowing removal of accumulated solid residues.

9. The system of claim 1, wherein the thermal evaporation unit is configured to receive wastewater in an atomized form prior to exposure to the combustion system.

10. The system of claim 9, wherein the atomized wastewater is introduced into a combustion region of the combustion system to promote rapid evaporation and thermal treatment.

11. The system of claim 10, wherein the solids discharge valve comprises a double dump valve arrangement or a rotary airlock valve.

12. The system of claim 5, wherein the screw conveyor is configured to transport collected solids from the thermal evaporation unit to an external collection container.

13. The system of claim 12, wherein the external collection container comprises a roll-off container configured to receive dried solid residues.

14. The system of claim 1, wherein the combustion system receives combustion air from a combustion or dilution air source configured to support burner operation.

15. The system of claim 1, wherein the vapor treatment section is configured to release a treated vapor stream to the atmosphere after removal of particulate matter.

16. The system of claim 1, wherein the combustion system and the thermal evaporation unit are configured to thermally oxidize dissolved chemical compounds present in the wastewater during the evaporation process.

17. The system of claim 16, wherein the dissolved chemical compounds include organic additives present in hydraulic fracturing fluids.
